(19) United States
(12) Patent Application Publication
(10) Pub. No.: US 2004/0246637 A1
(43) Pub. Date: Dec. 9, 2004

(54) Motor condition detection apparatus and vehicle height control apparatus

(75) Inventors: Wataru Tanaka, Toyota-shi (JP); Toshiaki Hamada, Okazaki-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/809,541

(22) Filed: Mar. 26, 2004

(30) Foreign Application Priority Data
Mar. 28, 2003 (JP) 2003-092423

(51) Int. Cl. H02H 7/08

(52) U.S. Cl. 361/23

(57) ABSTRACT

A motor condition detection apparatus detects motor driving voltage of driving electric source supplied to a motor and detects voltage of a control device for driving and controlling the motor. The apparatus calculates voltage difference between the motor driving voltage and the voltage of the control device. The apparatus provisionally determines the motor locking condition based on the voltage difference during driving of the motor and the apparatus stops driving the motor after the motor locking condition is provisionally determined. The apparatus detects regenerative voltage of the motor when driving of the motor is stopped and finally determines the motor locking condition based on the regenerative voltage.

### CROSS REFERENCE TO RELATED APPLICATIONS

This application is based on and claims priority under 35 U.S.C.§119 with respect to Japanese Patent Application 2003-092423, filed on Mar. 28, 2003, the entire content of which is incorporated herein by reference.

### FIELD OF THE INVENTION

This invention relates to a motor condition detection apparatus. For example, the invention can be applied for a vehicle height control apparatus.

### BACKGROUND OF THE INVENTION

A known vehicle height control apparatus using a motor condition detection apparatus is disclosed in e.g. Japanese laid-open publication No. 06(1994)-227235 published on Aug. 16, 1994. The height control apparatus supplies pressurized air to an air pressure chamber of a shock absorber and discharges pressurized air from the air pressure chamber to change the pressure in the air pressure chamber and thus to control vehicle height. In detailed, if the vehicle height becomes lower by e.g. increase of occupant number, a blocking valve provided in an air passage connecting the air pressure chamber to a compressor is opened. As a result, the pressurized air is supplied from the compressor to the air pressure chamber and the vehicle height is raised. If the vehicle height becomes higher by e.g. decrease of occupant number, a motor driving the compressor is turned off and an atmosphere releasing valve provided in the air passage is opened. As a result, the pressurized air in the air pressure chamber is discharged to atmosphere and the vehicle height is gone down.

If the motor is locked due to e.g. the mechanical malfunction, excess high air pressure in the discharging side of the compressor, high electric current is flowed in the motor and thus both the motor and the wiring harness may be damaged. Thus, in the above height control apparatus, the locking condition of the motor is detected by the motor condition detection apparatus. The current flowed in the motor is compared with a predetermined value to determine whether or not the motor is locked. Though the detailed explanation is not described in the Japanese publication, the current value of the motor is generally calculated as follows: A shunt resistor with low resistor value is provided between the motor and a ground and the voltage occurred at both ends of the shunt resistor is amplified by an amplifying circuit. After that, the amplified voltage is converted to digital signal by A/D converter to calculate the current value of the motor.

However, as explained above, because the current value of the motor is detected to detect the motor locking condition in the known apparatus, at least the shunt resistor and the amplifying circuit are needed and thus the apparatus is expensive.

A need exists for a motor condition detection apparatus which is not susceptible to the drawback mentioned above.

### SUMMARY OF THE INVENTION

According to the first aspect of this invention, a motor condition detection apparatus comprises the first voltage detection means for detecting motor driving voltage and the second voltage detection means for detecting voltage of a control device driving and controlling the motor. Voltage difference calculation means calculates voltage difference between the motor driving voltage and the voltage of the control device. Motor locking determination means determines that the motor is locked when the voltage difference is higher than a predetermined voltage.

According to the second aspect of this invention, the motor condition detection apparatus comprises voltage detection means for detecting motor driving voltage and ripple intensity calculation means for calculating ripple intensity of the motor driving voltage. Motor locking determination means determines that the motor is locked when the ripple intensity is smaller than a predetermined value.

According to the third aspect of this invention, in addition to the first or second aspect, the motor condition detection apparatus further comprises motor driving stopping means for stopping driving the motor after the motor locking determination means provisionally determines that the motor is locked. Regenerative voltage detection means detects regenerative voltage of the motor when driving of the motor is stopped and main motor locking determination means determines the motor locking condition based on the regenerative voltage of the motor.

### BRIEF DESCRIPTION OF THE DRAWING FIGURES

The foregoing and additional features and characteristics of the present invention will become more apparent from the following detailed description considered with reference to the accompanying drawing figures, in which like reference numerals designate like elements.

FIG. 1 is an outline view of a vehicle height control apparatus according to the first embodiment of the present invention.

FIG. 2 is an outline view showing the structure for detecting the driving voltage of the motor and the controlling voltage of the controller.

FIG. 3 is a flow chart showing the operation of the vehicle height control apparatus in FIG. 1.

FIG. 4 is a flow chart showing the process of the preliminary motor locking determination in FIG. 3.

FIG. 5 is a flow chart showing the process of the main motor locking determination in FIG. 3.

FIG. 6 is a flow chart showing the process of the main motor locking determination according to the second embodiment of the present invention.

### DETAILED DESCRIPTION OF THE INVENTION

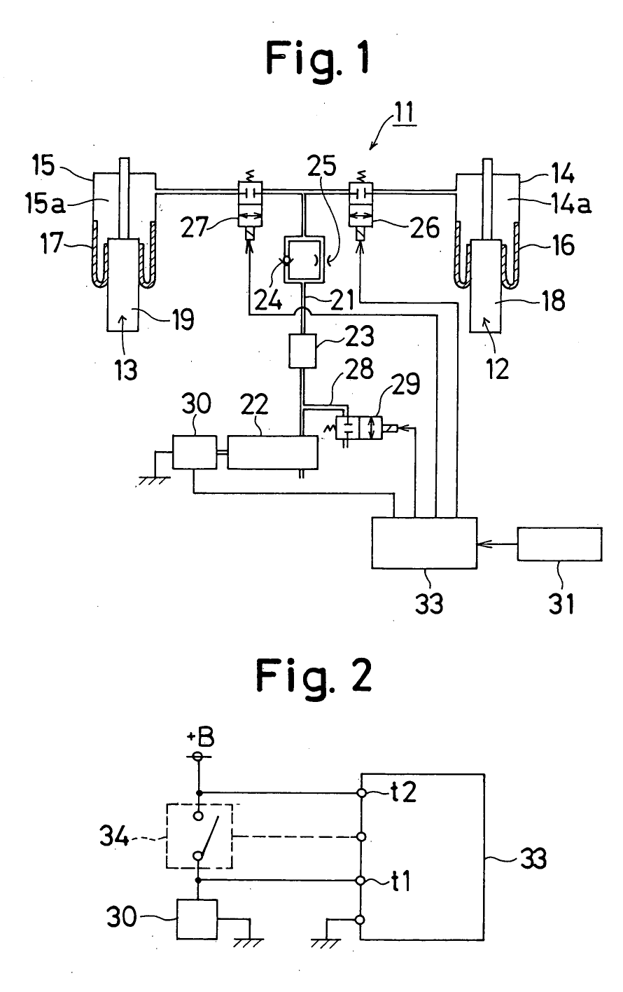

The motor condition detection apparatus according to this invention can be used for a motor normally equipped with a vehicle and the use of this invention is not limited. Hereinafter, embodiments embodying the invention are explained in accordance with FIGS. 1 to 6.

FIG. 1 is an outline view of a vehicle height control apparatus 11 using the invention. A pair of shock absorbers 12,13 (height control device) include outer cover shells 14,15 respectively. The shock absorbers 12,13 are provided in an air suspension apparatus of the vehicle. An air pressure chamber 14a (15a) is formed in each outer cover shell 14 (15). A diaphragm 16 (17) is provided at opening end of each outer cover shell 14 (15) and an absorber cylinder 18 (19) is connected to the diaphragm 16 (17) in such a manner that it seals the air pressure chamber 14a (15a) hermetically. If pressurized air is supplied to or discharged from the air pressure chambers 14a,15a in the outer cover shells 14,15, the moving amount of the absorber cylinders 18, 19 are changed in response to the air pressure and thus the vehicle height can be controlled.

A compressor 22 is connected to each outer cover shell 14 (15) through an air passage 21 which can be communicated with the air pressure chambers 14a, 15a to supply the pressurized air to the air pressure chambers 14a,15a. The compressor is driven by an electric motor 30. The air passage 21 is branched on the way toward each shock absorber 12,13 and an air drier 23, a check valve 24 and an orifice 25 are provided at the upper stream side of the branched junction in the air passage 21. The check valve 24 and the orifice 25 are connected in parallel each other and they keep the low pressure condition in the air drier 23 when the vehicle height is gone down.

A blocking valve 26 (27) (control valve) is provided in each branch passage of the air passage 21 as control valve of each shock absorber 12 (13). The blocking valves 26,27 are normally closed solenoid valves and opened when the solenoid is energized. A discharge passage 28 is connected to the air passage 21 between the compressor 22 and the air drier 23 and the discharge passage 28 is communicated with atmosphere. An atmosphere releasing valve 29 is provided in the discharge passage 28. The atmosphere releasing valve 29 is normally closed solenoid valve and opened when the solenoid is energized.

The blocking valves 26,27 the atmosphere releasing valve 29 and the motor 30 are electrically connected to a controller 33 (control device). A height sensor 31 as a height detection means is also electrically connected to the controller 33 to detect the vehicle height and outputs the height signal it to the controller 33. When the height signal is inputted from the height sensor 31 to the controller 33, the controller 33 drives and controls the motor 30 and controls the blocking valves 26,27 and the atmosphere releasing valve 29 and thereby controls the vehicle height to a set value.

Both the first and second voltage detection means of this invention are incorporated in the controller 33. The controller 33 detects both control voltage which is voltage of electric source of the controller 33 and motor driving voltage which is voltage of driving source when the motor 30 is rotated actually. As shown in FIG. 2, the controller 33 controls the motor 30 via a relay 34 and a battery electric source is supplied from a battery B to the motor 30 via the relay 34. A first input terminal t1 of the controller 33 is connected to the electric source terminal of the motor 30 and a second input terminal t2 of the controller 33 is connected to a terminal at upstream of the relay 34, e.g. a battery terminal. Further, a ground terminal of the controller 33 is connected to a ground terminal of the motor 30 via e.g. a vehicle frame (not shown) etc.

Thus, the controller 33 detects the motor driving voltage in the electric source terminal of the motor 30 at the first input terminal t1 and detects the control voltage (battery voltage) at the second terminal t2. Normally, the above voltage is detected through an A/D converter incorporated in the controller 33. The input terminals t1,t2 are terminals to detect the voltage at different positions in the wiring harness and the position in the wiring harness to which they are connected is decided in such manner that potential difference between the first and second terminals t1,t2 can be detected when the motor 30 is locked. So, when the motor 30 is locked, different voltages are detected at the first and second terminals t1,t2. The A/D converter can be omitted by using an analog circuit. The controller 33 calculates a voltage difference between the control voltage and the motor driving voltage (voltage difference calculation means) and determines whether or not the motor current is higher than a certain value based on the voltage difference.

The controller 33 calculates the ripple intensity of the motor driving voltage during driving of the motor 30 (ripple intensity calculation means) and determines whether or not the ripple intensity is smaller than a predetermined value. If the controller 33 determines that the ripple intensity is smaller than the predetermined value and the voltage difference is higher than a predetermined voltage, the controller 33 turns off the relay 34 to stop energizing the motor 30. The ripple of the motor driving voltage means alternating current components in the motor driving voltage and the ripple is caused by the movement of the motor 30 or the compressor 22 driven by the motor.

The controller 33 detects motor regenerative voltage occurred when energizing to motor 30 is stopped and determines whether or not the motor 30 is locked based on the motor regenerative voltage. The motor regenerative voltage means the voltage occurred from the rotation of the motor 30 by the inertia when energizing to motor 30 is stopped.

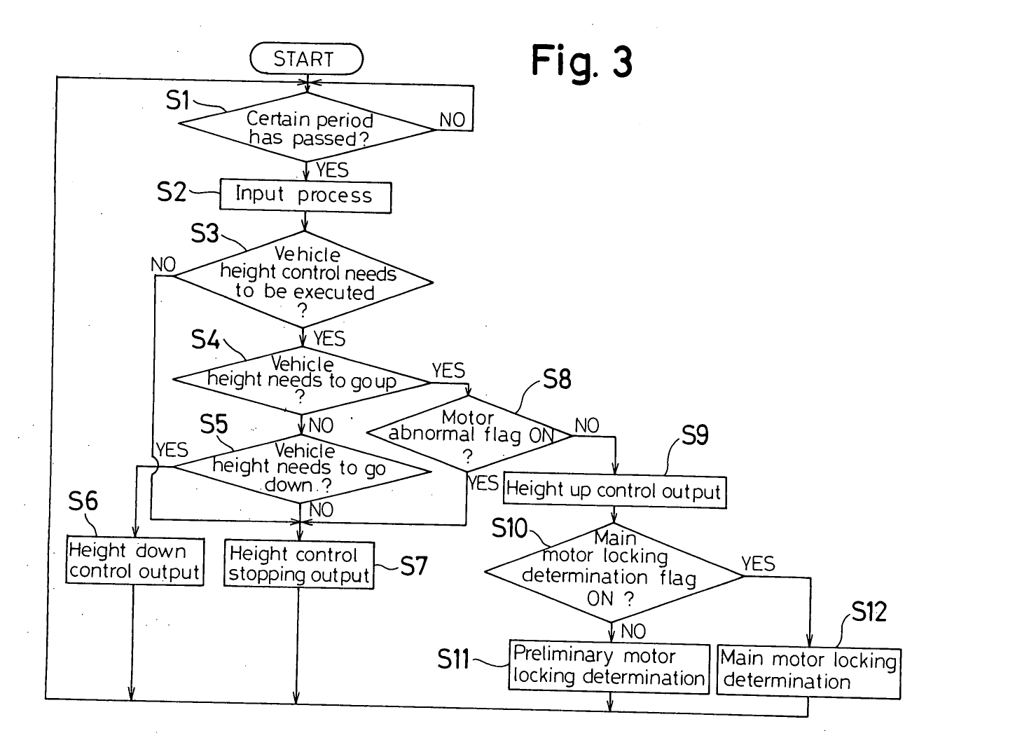

Hereinafter, the operation of the vehicle height control apparatus 11 is explained in accordance with the flow chart in FIGS. 3-5. This flow chart is executed by a CPU (not shown) of the controller 33 based on control program memorized in a memory (not shown) of the controller 33.

If a certain period has passed since start of the height control (S1), the height signal is inputted from the height sensor 31 (S2) and it is determined if the vehicle height control needs to be executed based on the height signal (S3). If the vehicle height is higher than a set value and thus it is determined that the vehicle height needs to be gone down, energizing to the motor 30 is stopped and both the blocking valves 26,27 and the atmosphere releasing valve 29 are opened. As a result, the pressurized air in the air pressure chambers 14a,15a of the outer cover shells 14,15 is discharged to atmosphere and thus the vehicle height is gone down (S6).

If the vehicle height is equal to the set value and it is determined in the step S3 that the vehicle height control does not need to be executed, energizing to the motor 30 is stopped and both the blocking valves 26,27 and the atmosphere releasing valve 29 are closed and the vehicle height control is terminated or not started (S7).

If the vehicle height is lower than the set value and it is determined that the vehicle height needs to be raised or gone up (S4), it is determined whether or not the motor 30 driving the compressor 22 is abnormal, i.e. locking condition by a motor abnormal flag which is normally OFF (S8). If the motor 30 is abnormal, the program proceeds to the step S7 and energizing to the motor 30 is stopped. If the motor 30 is normal, the motor 30 is driven, the blocking valves 26,27 are opened and further the atmosphere releasing valve 29 are closed. As a result, the pressurized air is supplied to the air pressure chambers 14a,15a of the outer cover shells 14, 15 and thus the vehicle height is raised (S9). The steps S1-S9 correspond to the process of “control device” in the claims.

Next, it is determined that a main motor locking determination needs to be executed using a main motor locking determination flag (S10). The main motor locking determination flag is set (ON) when it is determined in a preliminary motor locking determination (S11) that the main motor locking determination needs to be executed and it is reset (OFF) in the main motor locking determination (S12). The initial condition of the main locking determination flag is OFF.

Thus, in case the main motor locking determination does not need to be executed (the main locking determination flag is OFF), the preliminary motor locking determination is executed, in which the locking condition of the motor 30 is preliminarily or provisionally determined (S11). In case the main motor locking determination needs to be executed (the main locking determination flag is ON), the main motor locking determination is executed, in which the locking condition of the motor 30 is formally determined (S12).

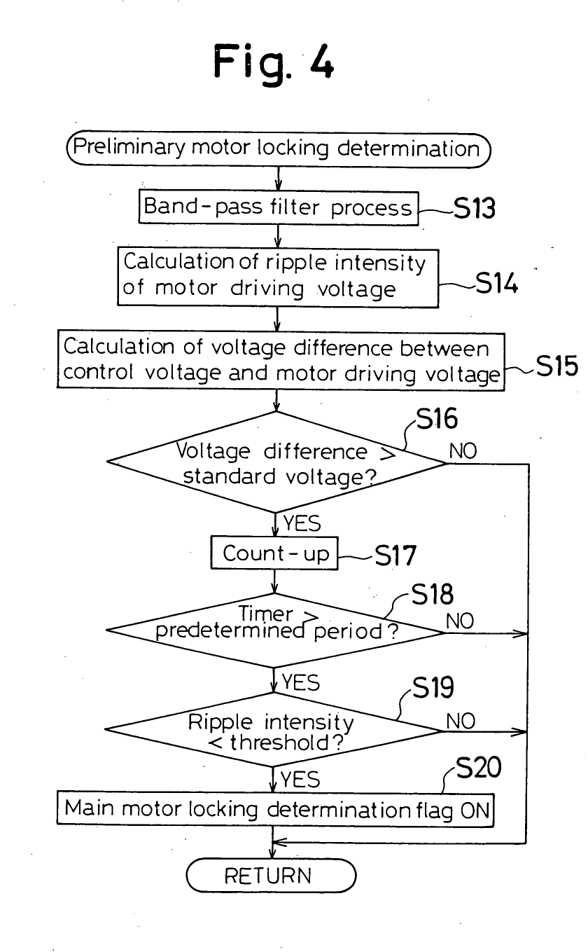

As shown in FIG.4, in the preliminary motor locking determination, the driving voltage of the motor 30 is processed through a band-pass filter (BPF) when the vehicle height is raised and thereby the ripple of the driving voltage is detected (S13). Then, ripple intensity is calculated by averaging absolute value of the ripple detected within a predetermined period (S14: ripple intensity calculation means).

Then, the voltage difference between the control voltage of the controller 33 and the driving voltage of the motor 30 is calculated (S15: voltage difference calculation means). It is determined whether or not the voltage difference is higher than a predetermined standard voltage (S16). As a result, if the voltage difference is lower than the standard voltage, the preliminary motor locking determination is terminated and the program returns to the main routine shown in FIG. 3. If the voltage difference is equal to or higher than the standard voltage, a timer is counted (S17) and it is determined whether or not the high condition in which the voltage difference is higher continues for more than a predetermined period (S18). If the high condition of the voltage difference does not continue for more than the predetermined period, the preliminary motor locking determination is terminated, but if the high condition of the voltage difference continues for more than the predetermined period, it is determined whether or not the ripple intensity calculated at the step S14 exceeds a threshold value (S19). If the ripple intensity exceeds the threshold value, the preliminary motor locking determination is terminated and the program returns to the main routine shown in FIG. 3. If the ripple intensity does not exceed the threshold value, it is determined preliminarily or provisionally that the motor is locked, the main locking determination flag is set to ON (S20) and a count value of the timer is increased from 0 (zero), and then the program returns to the routine in FIG. 3. The steps S16-S20 correspond to the process of the “first motor locking determination means” in this invention.

If the motor 30 is rotated normally, the current flowed in the wiring harness supplying the electric source to the motor is lower and thus voltage drop in the wiring harness is small. For that reason, the voltage difference between the control voltage of the controller 33 and the motor driving voltage is lower than the predetermined standard voltage. On the contrary, if the motor 30 is locked during driving, the current flowed in the wiring harness supplying the electric source to the motor is higher than that of normal condition and thus voltage drop in the wiring harness is greater. As a result, the voltage difference is higher than the predetermined standard voltage.

Further, if the motor 30 is rotated normally, the ripple intensity of the motor driving voltage is greater than the threshold value because the ripple is occurred by the movement of the motor 30 and the compressor 22. On the contrary, if the motor 30 is locked during driving, the motor 30 is not rotated and the compressor 22 is not driven. As a result, the ripple intensity of the motor driving voltage is smaller than the threshold value.

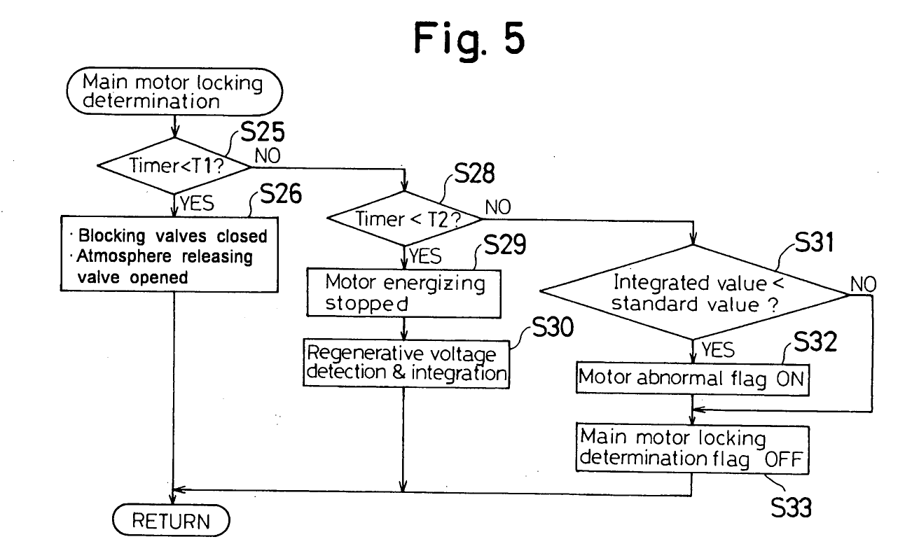

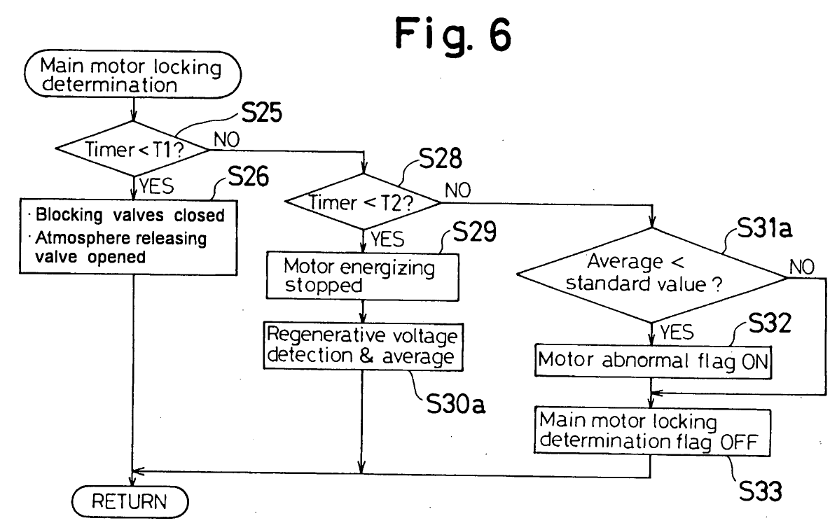

FIG. 5 is a flow chart showing the process of the main motor locking determination (S12) in FIG. 3. At first, the count value of the timer is compared with the first predetermined time T1 (S25), if the count value is smaller than the first predetermined time T1, i.e. until the first predetermined time T1 has passed, the blocking valves 26,27 are closed and the atmosphere releasing valve 29 is kept open (S26).

If the count value is greater than the first predetermined time T1, the count value of the timer is compared with the second predetermined time T2 greater than the first predetermined time T1 (S28). If the count value is smaller than the second predetermined time T2, the energizing to the motor 30 is stopped (S29: “motor driving stopping means”). Then, the regenerative voltage of the motor 30 is detected and the regenerative voltage is further integrated (S30: “regenerative voltage detection means”) in order to reduce the influence to the main motor locking determination by noises occurred when the regenerative voltage is detected. To reduce the influence by noises, instead of the integration, the regenerative voltage detected within a predetermined period may be averaged or a filter may be used in a regenerative voltage detection circuit.

If the count value of the timer is greater than the second predetermined time T2, it is determined whether or not the integrated value of the motor regenerative voltage is higher than a standard value (S31). If the integrated value of the regenerative voltage is lower than the standard value, it is determined that the motor 30 is locked and the motor abnormal flag is set to ON (S32). Then, the main locking determination flag is reset (OFF) and the main motor locking determination is terminated (S33). As a result, it is determined at the step S8 in FIG. 3 that the motor 30 is abnormal and the vehicle height control is terminated at the step S7. The step S31, S32 correspond to the process of the “second motor locking determination means” in this invention.

If the integrated value of the motor regenerative voltage is greater than the standard value, it is determined that the motor 30 is not locked and the main locking determination flag is OFF and the main motor locking determination is terminated (S33). At this time, because the motor abnormal flag is OFF, it is determined at the step S8 in FIG. 3 that the motor 30 is normal and the vehicle height is raised at the step S9.

When driving (energizing) the motor 30 is stopped, unless the motor 30 is not locked, the motor 30 tries to keep rotating by inertia because the motor 30 functions as a generator. For that reason, the regenerative current is flowed in the motor 30 and the regenerative voltage is gradually reduced. On the contrary, if the motor 30 is locked, the regenerative voltage is not occurred because the motor 30 is not rotated. By using this characteristic, the main locking determination is executed.

Thus, according to this embodiment, there are the following effects or advantages:

(1) After the preliminary (provisional) motor locking determination is executed during driving of the motor 30 (during raising of the vehicle height), the main motor locking determination is executed by detecting the motor regenerative voltage when the energizing to the motor 30 is stopped. Since neither the preliminary or main determination needs to detect the electric current energized to the motor 30, additional components such as the shunt resistor and the amplifying circuit is not needed. Thus, the motor condition detection apparatus in the vehicle height control apparatus is cheaper than the known apparatus.

(2) By both preliminary and main locking determinations, the motor locking can be detected more accurately than either one determination.

(3) The motor locking condition can be watched during driving of the motor 30, i.e. height raising control because the preliminary motor locking determination is executed based on the voltage difference between the motor driving voltage and the control voltage of the controller 33, and the ripple of the motor driving voltage occurred necessarily when the motor 30 is rotated.

(4) The preliminary motor locking determination is executed by two conditions, i.e. the first condition in which the voltage difference between the motor driving voltage and the control voltage is higher than the standard voltage and the second condition in which the ripple of the motor driving voltage is smaller than the predetermined value. Thus, the preliminary motor locking determination can be executed more accurately in comparison with either one condition.

(5) The regenerative voltage detected within a predetermined time (T2-T1) after stopping energizing to the motor 30, is integrated. Thus, the influence to the main motor locking determination by noises occurred when the regenerative voltage is detected, can be reduced. As a result, the main motor locking determination can be executed more accurately.

(6) Before the energizing to the motor 30 is stopped, the atmosphere releasing valve 29 is opened and thereby the air passage 21 at the discharge side of the compressor 22 is released to the atmosphere. For that reason, when the energizing to the motor 30 is stopped, the resistant force against motor's rotation by inertia is reduced unless the motor 30 is locked. Thus, regenerative electric power can be generated sufficiently.

(7) In case the motor 30 driving the compressor 22 is locked, if the vehicle height is tried to raise, the compressor 22 is not driven and thus the pressurized air can not be supplied to the air pressure chamber 14a,15a. According to the motor locking determination according to this embodiment, it can be accurately determined that the motor 30 is locked.

Hereinafter, the second embodiment employing this invention is explained. In the second embodiment, the explanation on the same portions as the first embodiment is omitted and different portions from the first embodiment are mainly explained.

As shown in FIG. 6, in the main motor locking determination process executed by the controller 33, the average value of the motor regenerative voltage detected within a predetermined period after stopping energizing to the motor 30 is calculated (S30a: “regenerative voltage detection means”). It is determined whether or not the average value of the motor regenerative voltage is higher than a standard value (S31a). If the average value is lower than the standard value, it is determined that the motor 30 is locked and the motor abnormal flag is set to ON (S32). Thus, the influence to the main motor locking determination by noises occurred when the regenerative voltage is detected, can be reduced. As a result, the main motor locking determination can be executed more accurately. The steps 31a, 32 correspond to the process of the “second motor locking determination means” in this invention.

This embodiment may be modified as follows:

Though both the preliminary and main motor locking determinations are executed to detect the motor locking condition, the main motor locking determination can be omitted.

Though the controller 33 detects the motor driving voltage in the above embodiments, instead of this, a voltage sensor (not shown) may be connected to the source terminal of the motor 30 to detect the motor driving voltage (“first voltage detection means”).

The preliminary motor locking determination may be executed only by watching or using the voltage difference between the motor driving voltage and the control voltage. In this case, when the voltage difference is higher than the standard voltage during the vehicle height rise, it is preliminarily or provisionally determined that the motor 30 is locked (“first motor locking determination means”) and the energizing to the motor 30 is stopped for the main motor locking determination.

The preliminary motor locking determination may be executed only by watching or using the ripple intensity of the motor driving voltage. In this case, when the ripple intensity of the motor driving voltage is smaller than the predetermined value, it is preliminarily or provisionally determined that the motor 30 is locked (“first motor locking determination means”) and the energizing to the motor 30 is stopped for the main motor locking determination.

The main motor locking determination may be executed by both the integrated value of the regenerative voltage and the average value thereof within the predetermined time after the energizing to the motor 30 is stopped. In this case, if the integrated value of the regenerative voltage is smaller than the standard integration value and if the average value of the regenerative voltage is smaller than the standard average value, it is determined that the motor 30 is locked. Thus, the main motor locking determination can be executed more accurately.

Though the vehicle height control apparatus embodying the motor condition detection apparatus in the above embodiments, this invention can be used for any other apparatus such as Anti-lock Brake System (ABS), Traction Control System, Electric Stability Control System preventing lateral skidding (oversteer and understeer) of the vehicle.

The principles, preferred embodiments and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A motor condition detection apparatus for detecting a locking condition of the motor comprising:
first voltage detection means for detecting motor driving voltage of driving electric source supplied to the motor;
second voltage detection means for detecting voltage of a control device for driving and controlling the motor;
voltage difference calculation means for calculating voltage difference between the motor driving voltage and the voltage of the control device; and
first motor locking determination means for determining the locking condition of the motor based on the voltage difference during driving of the motor and the first motor locking determination means determining that the motor is locked when the voltage difference is higher than a predetermined voltage.

2. A motor condition detection apparatus according to claim 1 further comprising:
motor driving stopping means for stopping driving the motor after the first motor locking determination means provisionally determines that the motor is locked;
regenerative voltage detection means for detecting regenerative voltage of the motor when driving of the motor is stopped; and
second motor locking determination means for determining the locking condition of the motor based on the regenerative voltage of the motor.

3. A motor condition detection apparatus according to claim 2, wherein the motor driving stopping means stops driving the motor in a predetermined period after the first motor locking determination means provisionally determines that the motor is locked.

4. A motor condition detection apparatus according to claim 2, wherein the regenerative voltage detection means integrates the regenerative voltage detected within a predetermined period after driving of the motor is stopped to calculate an integration value and the second motor locking determination means finally determines that the motor is locked when the integration value is smaller than a standard value.

5. A motor condition detection apparatus according to claim 2, wherein the regenerative voltage detection means averages the regenerative voltage detected within a predetermined period after driving of the motor is stopped to calculate an average value and the second motor locking determination means finally determines that the motor is locked when the average value is smaller than a standard value.

6. A motor condition detection apparatus according to claim 1, wherein the first motor locking determination means determines that the motor is locked when the condition in which the voltage difference is higher than the predetermined voltage continues for a predetermined period.

7. A motor condition detection apparatus according to claim 1 further comprising ripple intensity calculation means for calculating ripple intensity of the motor driving voltage, wherein the first motor locking determination means determines that the motor is locked when the voltage difference is higher than the predetermined voltage and when the ripple intensity is smaller than a predetermined value.

8. A motor condition detection apparatus according to claim 7, wherein ripple intensity calculation means averages an absolute value of the ripple within a predetermined period to calculate the ripple intensity.

9. A motor condition detection apparatus according to claim 1, wherein the motor is connected to an electric source through a connecting line including a relay, the first voltage detection means connects to the connecting line between the relay and the motor and the second voltage detection means connects to the connecting line between the electric source and the relay.

10. A motor condition detection apparatus for detecting a locking condition of the motor comprising:
voltage detection means for detecting motor driving voltage of driving electric source supplied to the motor;
ripple intensity calculation means for calculating ripple intensity of the motor driving voltage; and
first motor locking determination means for determining the locking condition of the motor based on the ripple intensity of the motor driving voltage during driving of the motor and the first motor locking determination means determining that the motor is locked when the ripple intensity is smaller than a predetermined value.

11. A motor condition detection apparatus according to claim 10 further comprising:
motor driving stopping means for stopping driving the motor after the first motor locking determination means provisionally determines that the motor is locked;
regenerative voltage detection means for detecting regenerative voltage of the motor when driving of the motor is stopped; and
second motor locking determination means for determining the locking condition of the motor based on the regenerative voltage of the motor.

12. A motor condition detection apparatus according to claim 10, wherein ripple intensity calculation means averages an absolute value of the ripple within a predetermined period to calculate the ripple intensity.

13. A motor condition detection apparatus for detecting a locking condition of the motor comprising:
first voltage detection means for detecting motor driving voltage of driving electric source supplied to the motor;
motor driving stopping means for stopping driving the motor based on the motor driving voltage during driving condition of the motor;
regenerative voltage detection means for detecting regenerative voltage of the motor when driving the motor is stopped; and
motor locking determination means for determining the locking condition of the motor based on the regenerative voltage of the motor.

14. A motor condition detection apparatus according to claim 13 further comprising second voltage detection means for detecting voltage of a control device for driving and controlling the motor and voltage difference calculation means for calculating voltage difference between the motor driving voltage and the voltage of the control device, and wherein the motor driving stopping means stops driving the motor when the voltage difference is higher than a predetermined voltage.

15. A motor condition detection apparatus according to claim 13 further comprising ripple intensity calculation means for detecting ripple intensity of the motor driving voltage and wherein the motor driving stopping means stops driving the motor when the ripple intensity is smaller than a predetermined value.

16. A motor condition detection method for detecting a locking condition of the motor comprising steps of:
detecting motor driving voltage of driving electric source supplied to the motor;
detecting voltage of a control device for driving and controlling the motor;
calculating voltage difference between the motor driving voltage and the voltage of the control device; and
first determining the locking condition of the motor based on the voltage difference during driving of the motor.

17. A motor condition detection method according to claim 16 further comprising steps of:
stopping driving the motor after the first determining step provisionally determines that the motor is locked;
detecting regenerative voltage of the motor when driving of the motor is stopped; and
second determining the locking condition of the motor based on the regenerative voltage of the motor.

18. A motor condition detection method according to claim 17, wherein the regenerative voltage detecting step integrates the regenerative voltage detected within a predetermined period after driving of the motor is stopped to calculate an integration value and the second determining step finally determines that the motor is locked when the integration value is smaller than a standard value.

19. A motor condition detection method according to claim 17, wherein the regenerative voltage detecting step averages the regenerative voltage detected within a predetermined period after driving of the motor is stopped to calculate an average value and the second determining step finally determines that the motor is locked when the average value is smaller than a standard value.

20. A motor condition detection method according to claim 16 further comprising a step of calculating ripple intensity of the motor driving voltage, wherein the first determining step provisionally determines that the motor is locked when the voltage difference is higher than the predetermined voltage and when the ripple intensity is smaller than a predetermined value.

21. A motor condition detection method for detecting a locking condition of the motor comprising steps of:
detecting motor driving voltage of driving electric source supplied to the motor;
detecting ripple intensity of the motor driving voltage; and
first determining the locking condition of the motor based on the ripple intensity of the motor driving voltage during driving of the motor.

22. A motor condition detection method according to claim 21 further comprising steps of:
stopping driving the motor after the first determining step provisionally determines that the motor is locked;
detecting regenerative voltage of the motor when driving of the motor is stopped; and
second determining the locking condition of the motor based on the regenerative voltage of the motor.

23. A vehicle height control apparatus for controlling a vehicle height comprising:
a height control device having an air pressure chamber and controlling the vehicle height by air pressure supplied to or discharged from the air pressure chamber;
a compressor supplying pressurized air to the air pressure chamber;
a motor driving the compressor;
a control valve provided in an air line formed between the compressor and the air chamber to control the air pressure in the air pressure chamber;
an atmosphere releasing valve provided in the air line between the control valve and the compressor so as to release the air pressure in the air pressure chamber to an atmosphere;
a height detection sensor detecting the vehicle height;
control device controlling the motor, the control valve and the atmosphere releasing valve based on the vehicle height detected by the height detection sensor; and
the motor condition detection apparatus according to claim 1.

24. A vehicle height control apparatus for controlling a vehicle height comprising:
a height control device having an air pressure chamber and controlling the vehicle height by air pressure supplied to or discharged from the air pressure chamber;
a compressor supplying pressurized air to the air pressure chamber;
a motor driving the compressor;
a control valve provided in an air line formed between the compressor and the air chamber to control the air pressure in the air pressure chamber;
an atmosphere releasing valve provided in the air line between the control valve and the compressor so as to release the air pressure in the air pressure chamber to an atmosphere;
a height detection sensor detecting the vehicle height;
control device controlling the motor, the control valve and the atmosphere releasing valve based on the vehicle height detected by the height detection sensor; and
the motor condition detection apparatus according to claim 10.

25. A vehicle height control apparatus for controlling a vehicle height comprising:
a height control device having an air pressure chamber and controlling the vehicle height by air pressure supplied to or discharged from the air pressure chamber;
a compressor supplying pressurized air to the air pressure chamber;
a motor driving the compressor;
a control valve provided in an air line formed between the compressor and the air chamber to control the air pressure in the air pressure chamber;
an atmosphere releasing valve provided in the air line between the control valve and the compressor so as to release the air pressure in the air pressure chamber to an atmosphere;
a height detection sensor detecting the vehicle height;
control device controlling the motor, the control valve and the atmosphere releasing valve based on the vehicle height detected by the height detection sensor; and
the motor condition detection apparatus according to claim 13.
